(19) United States
(12) Patent Application Publication
(10) Pub. No.: US 2014/0213078 A1
(43) Pub. Date: Jul. 31, 2014

(54) ELECTRONIC DEVICE AND CIRCUIT BOARD MODULE OF THE SAME

(71) Applicants: HON HAI PRECISION INDUSTRY CO., LTD., New Taipei (TW); HONG FU JIN PRECISION INDUSTRY (ShenZhen) CO., LTD., ShenZhen (CN)

(72) Inventors: HONG-LIAN HUANG, Shenzhen (CN); MEI HUANG, Shenzhen (CN); JIAN LUO, Shenzhen (CN); FANG-LI PAN, Shenzhen (CN)

(73) Assignees: HON HAI PRECISION INDUSTRY CO., LTD., New Taipei (TW); HONG FU JIN PRECISION INDUSTRY (ShenZhen) CO., LTD., ShenZhen (CN)

(21) Appl. No.: 13/974,396

(22) Filed: Aug. 23, 2013

(30) Foreign Application Priority Data
Jan. 31, 2013 (CN) 2013100375224

(51) Int. Cl. H01R 12/70

(52) U.S. Cl. CPC H01R 12/7082
USPC 439/76.1

(57) ABSTRACT

An electronic device includes an enclosure and a circuit board module received in the enclosure. The circuit board module includes a printed circuit board defining cutouts, connector units are arranged in the cutouts and electronically connected to the printed circuit board, creating a printed circuit board with a lower profile to allow utilization of more of the saved space above within the electronic device.

### BACKGROUND

1. Technical Field

The disclosure relates to electronic devices and, more particularly, to an electronic device having circuit board modules.

2. Description of Related Art

Electronic devices, such as servers, have at least one circuit board module. The circuit board module includes a plurality of connectors, such as registered jack-45 (RJ-45) connectors and universal serial bus (USB) connectors, which are directly set on the printed circuit board. However, the traditional layout of circuit board modules wastes space.

### BRIEF DESCRIPTION OF THE DRAWINGS

Many aspects of the present embodiments can be better understood with reference to the following drawing. The components in the drawing are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of an electronic device.

FIG. 2 is an exploded, isometric view of an embodiment of a circuit board module of the electronic device of FIG. 1.

FIG. 3 is an inverted view of the circuit board module of FIG. 2.

FIG. 4 is an assembled, isometric view of the circuit board module of FIG. 2.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

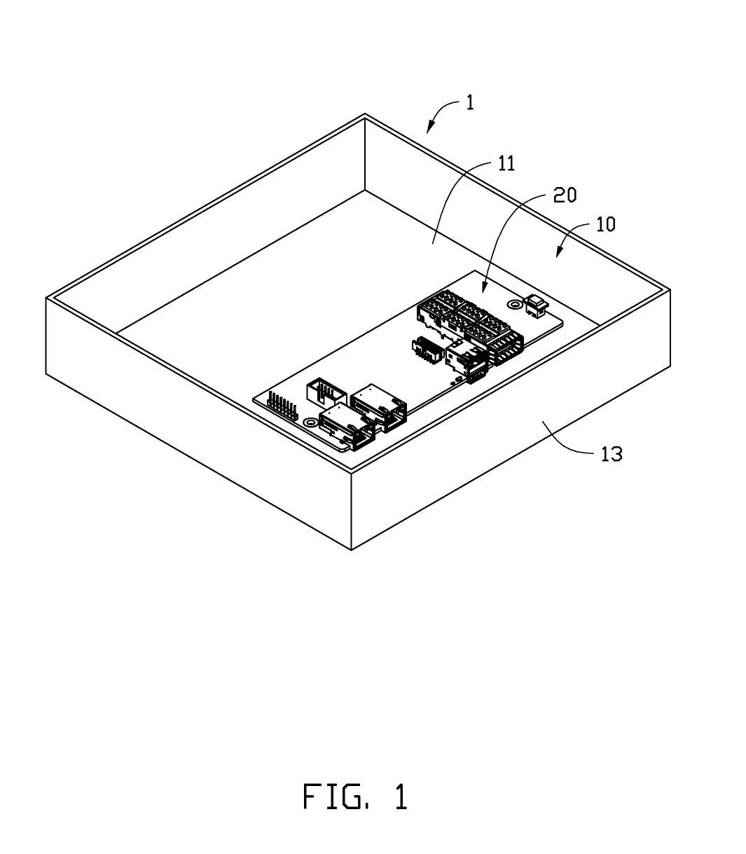

Referring to FIG. 1, an embodiment of an electronic device 1 includes an enclosure 10 and a circuit board module 20 received in the enclosure 10. The enclosure 10 includes a bottom plate 11 and four side plates 13 extending up from the bottom plate 11. The circuit board module 20 is supported on the bottom plate 11.

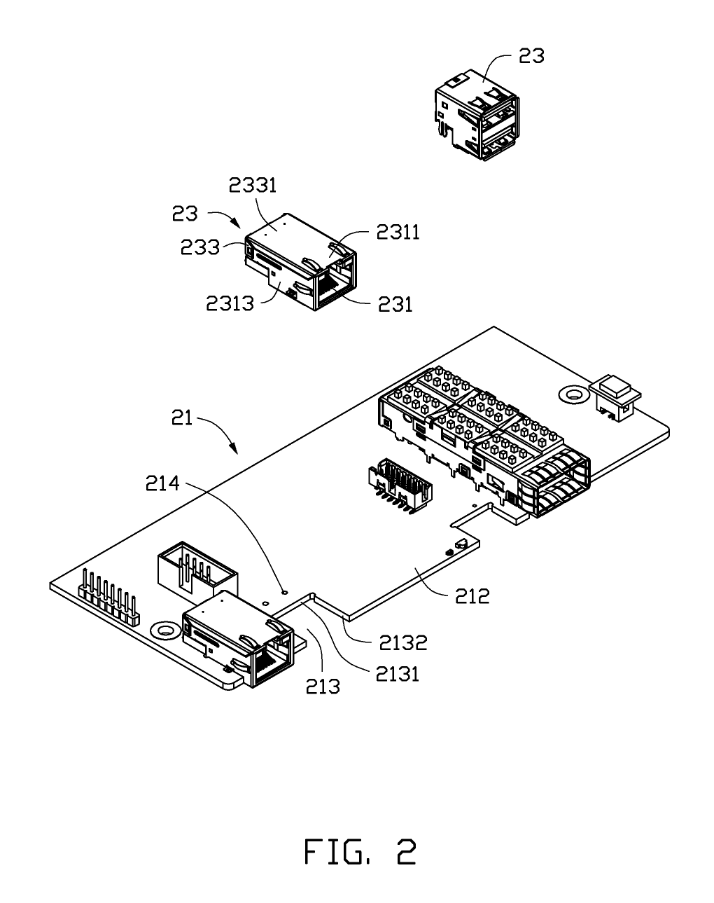

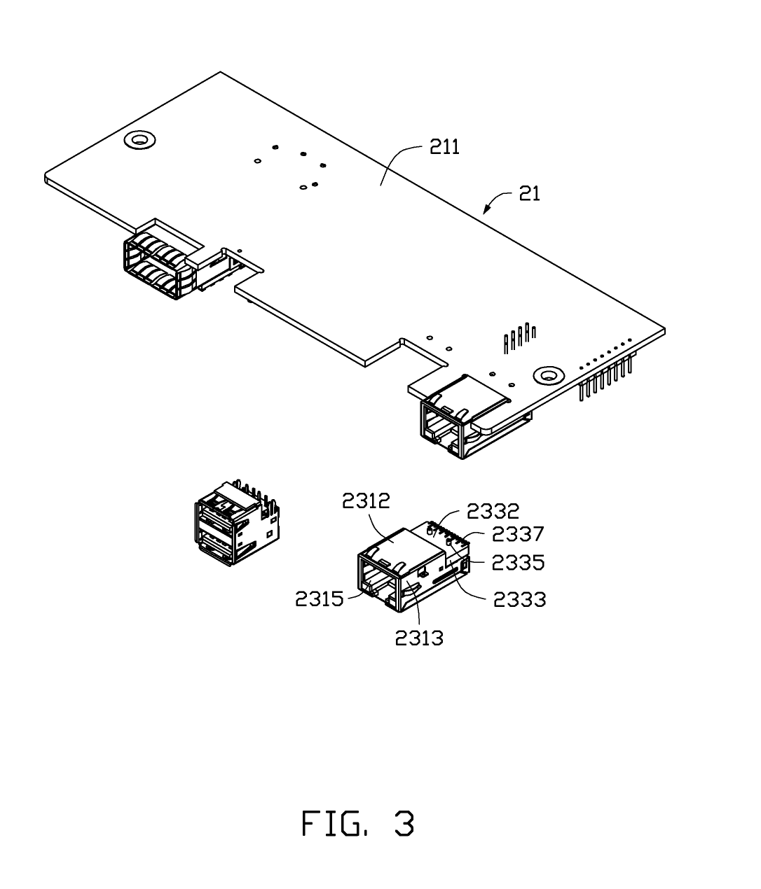

Referring to FIGS. 2 and 3, the circuit board module 20 includes a printed circuit board 21 and a plurality of connector units 23 set on the printed circuit board 21. The connector units 23 are registered jack-45 (RJ-45) connectors or universal serial bus (USB) connectors. The printed circuit board 21 includes a first side surface 211 facing the bottom plate 11 and a second side surface 212 opposite to the first side surface 211. A plurality of rectangular cutouts 213 is defined in a side of the printed circuit board 21. Each cutout 213 is bounded by a first sidewall 2131 and two substantially parallel second sidewalls 2132. The printed circuit board 21 defines two mounting holes 214 adjacent to the first sidewall 2131.

Each connector unit 23 includes a socket portion 231 and a connecting portion 233 located at a rear end of the socket portion 231. The connecting portion 233 is equal to the socket portion 231 in width and is less than the socket portion 231 in thickness. The socket portion 231 includes a top plate 2311, a bottom plate 2312, and two substantially parallel side plates 2313. The top plate 2311, the bottom plate 2312, and the substantially parallel side plates 2313 together bound a receiving space 2315 facing one of the side plates 13, for a peripheral connector to be plugged in. The connecting portion 233 includes a top plate 2331, a bottom plate 2332, and two substantially parallel side plates 2333. The top plate 2311 is substantially coplanar with the top plate 2331. Two posts 2335 protrude from the bottom plate 2332. A plurality of pins 2337 is set on one end of the connecting portion 233 away from the socket portion 231, and electrically connected to the socket portion 231.

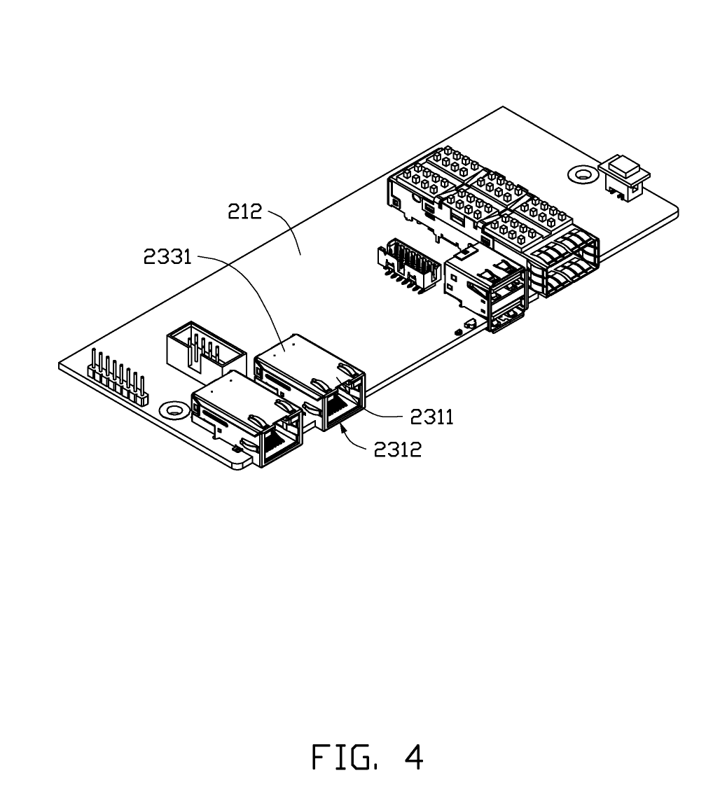

Referring to FIG. 4, the socket portion 231 is received in the cutout 213. The bottom plate 2332 is in contact with the second side surface 212. The posts 2335 are fixed in the mounting holes 214. The pins 2337 are electrically connected to the printed circuit board 21 by soldering. The side plates 2313 abut the second sidewalls 2132.

In this embodiment, the thickness difference between the socket portion 231 and the connecting portion 233 is substantially equal to the thickness of the printed circuit board 21. Thus the bottom plate 2312 is substantially coplanar with the first side surface 211.

In the embodiment, the printed circuit board 21 defines the cutouts 2213 for arranging the connector units 23, thereby bringing the connector units 23 closer to the bottom plate 11, which saves space above the printed circuit board 21 in the enclosure 10.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A circuit board module, comprising a printed circuit board and a connector unit, wherein the printed circuit board comprises a first side surface and defines a cutout, the connector unit comprises a socket portion and a connecting portion formed at a rear end of the socket portion, the socket portion is received in the cutout, and the connecting portion is fixed on the first side surface of the printed circuit board and electrically connected to the printed circuit board.

2. The circuit board module of claim 1, wherein the connector unit is a registered jack-45 connector or a universal serial bus connector.

3. The circuit board module of claim 1, wherein the cutout is bounded by a first sidewall and two substantially parallel second sidewalls, the printed circuit board defines two mounting holes adjacent to the first sidewall, and the connecting portion comprises two posts fixed in the mounting holes.

4. The circuit board module of claim 3, wherein the socket portion comprises a first top plate, a first bottom plate, and two substantially parallel first side plates; the first top plate, the first bottom plate, and the first side plates together bound a receiving space.

5. The circuit board module of claim 4, wherein the first side plates of the socket portion abut the second sidewalls bounding the cutout.

6. The circuit board module of claim 4, wherein the connecting portion comprises a second top plate substantially coplanar with the first top plate of the socket portion, a second bottom plate, and two substantially parallel second side plates; the posts protrude on the second bottom plate of the connecting portion.

7. The circuit board module of claim 6, wherein the connector unit further comprises a plurality of pins set on one end of the connecting portion away from the socket portion, and electrically connected to the socket portion and the printed circuit board.

8. The circuit board module of claim 6, wherein the printed circuit board further comprises a second side surface opposite to the first side surface, the connecting portion is thinner than the socket portion, a thickness difference between the socket portion and the connecting portion is substantially equal to a thickness of the printed circuit board, and the first bottom plate of the socket portion is substantially coplanar with the first side surface of the printed circuit board.

9. An electronic device, comprising:
an enclosure comprising a bottom plate and four side plates extending from the bottom plate;
a printed circuit board supported on the bottom plate of the enclosure, comprising a first side surface, and defining a cutout in a side of the printed circuit board; and
a connector unit comprising a socket portion and a connecting portion formed at a rear end of the socket portion, wherein the socket portion is received in the cutout, the connecting portion is fixed on the first side surface of the printed circuit board and electrically connected to the printed circuit board.

10. The electronic device of claim 9, wherein the connector unit is a registered jack-45 connector or a universal serial bus connector.

11. The electronic device of claim 9, wherein the cutout is bounded by a first sidewall and two substantially parallel second sidewalls, the printed circuit board defines two mounting holes adjacent to the first sidewall, and the connecting portion comprises two posts fixed in the mounting holes.

12. The electronic device of claim 11, wherein the socket portion comprises a first top plate, a first bottom plate, and two substantially parallel first side plates; the first top plate, the first bottom plate, and the first side plates together form a receiving space.

13. The electronic device of claim 12, wherein the first side plates of the socket portion abut the second sidewalls bounding the cutout.

14. The electronic device of claim 12, wherein the connecting portion comprises a second top plate substantially coplanar with the first top plate of the socket portion, a second bottom plate, and two substantially parallel second side plates; the posts protrude on the second bottom plate of the connecting portion.

15. The electronic device of claim 14, wherein the connector unit further comprises a plurality of pins set on one end of the connecting portion away from the socket portion, and electrically connected to the socket portion and the printed circuit board.

16. The electronic device of claim 14, wherein the printed circuit board further comprises a second side surface opposite to the first side surface, the connecting portion is thinner than the socket portion, a thickness difference between the socket portion and the connecting portion is substantially equal to a thickness of the printed circuit board, and the first bottom plate of the socket portion is substantially coplanar with the first side surface of the printed circuit board.

17. The electronic device of claim 12, wherein the receiving space faces towards one of the side plates of the enclosure.
